(19) United States
(12) Patent Application Publication
(10) Pub. No.: US 2006/0245593 A1
(43) Pub. Date: Nov. 2, 2006

(54) Secret information setting device and secret information setting method

(76) Inventors: Ikue Nakano, Osaka city (JP); Tatsuro Ikoma, Takatsuki city (JP); Hiroshi Yokota, Suita city (JP); Atsuhiro Tsuji, Minoh city (JP); Minoru Tamauchi, Toyota city (JP)

Correspondence Address: WENDEROTH, LIND & PONACK L.L.P., 2033 K. STREET, NW, SUITE 800, WASHINGTON, DC, 20006, US

(21) Appl. No.: 10/566,681

(22) PCT Filed: Dec. 14, 2004
(86) PCT No.: PCT/JP04/18988

§ 371 Date: Feb. 1, 2006

(30) Foreign Application Priority Data
Dec. 15, 2003 (JP) 2003-416189
Dec. 15, 2003 (JP) 2003-416188

(51) Int. Cl. H04L 9/00

(52) U.S. Cl. 380/277

(57) ABSTRACT

A secret information setting device includes a generation instruction receiving unit receiving a secret information generation instruction from a user; a secret information generation unit generating the secret information in response to the secret information generation instruction received with the generation instruction receiving unit; a secret information storage unit storing the secret information generated by the secret information generation unit; a secret information transfer unit transferring the secret information stored in the secret information storage unit to the plurality of appliances; and a secret information deleting unit deleting the secret information stored in the secret information storage unit when a predetermined condition is satisfied.

### TECHNICAL FIELD

The present invention relates to secret information setting devices and secret information setting methods for setting secret information in a plurality of appliances in a system that requires shared secret information that allows those appliances to communicate over a network.

### BACKGROUND ART

In recent years, IP (internet protocol) networks operating via the internet have spread rapidly, and there is a general trend for not only personal computers but also a wide variety of home appliances, such as AV equipment, surveillance cameras or IP telephones and the like, to be connected through IP networks. Moreover, IP networks are also becoming more widespread in homes, increasing the possibilities for providing communication services among home appliances. However, since communication among the home appliances generally takes place over a network, strategies against the threats of impersonation and eavesdropping are necessary.

Security techniques under consideration for protecting information from such threats include confirming whether the appliance communicated with is indeed the right appliance (appliance authentication), or encrypting the information that is exchanged with other appliances. In order to perform this type of appliance authentication or information encryption, it is necessary to share secret information that is known only to the communication appliances, such as a shared (encryption) key that is shared by a plurality of appliances.

For example, JP 2003-87238A proposes a method for setting secret information that is necessary for appliance authentication through the use of authentication tags. In this method for appliance authentication, home appliances connected to a network obtain the information necessary for authentication through the use of authentication tags, and the authentication information is stored in the memory of each of the home appliances. The home appliances perform the authentication between a key management device, based on the obtained authentication information and if the authentication is successful, receive a shared encryption key that is used for the communication in that household from the key management device. The home appliances encrypt information using the received shared encryption key, and encrypted communication is performed among the home appliances connected to the network in that household.

The conventional method for authenticating appliances disclosed in JP 2003-87238 A is described with reference to FIG. 12.

In FIG. 12, a home appliance 401 and a key management device 403 are connected via network connection unit 406 to a network 405 in a household. The home appliance 401 functions to read information that is written into an authentication tag 402. When the authentication tag 402 is inserted, the authentication information that is necessary for appliance authentication with the key management device 403 is obtained from the authentication tag 402, and stored in a predetermined region of the memory of the home appliance 401.

The home appliance 401 performs an authentication process with the key management device 403 using the authentication information obtained from the authentication tag 402, and obtains a shared encryption key for carrying out communication with other home appliances connected to the home network 405 from the key management device 403. The other home appliances connected to the network 405 obtain the shared encryption key in the same manner, and thus the home appliances connected via the network connection unit 406 to the network 405 can perform encrypted communication among each other.

Thus, with the method disclosed in JP 2003-87238A, the key management device manages a shared encryption key, which it distributes to the home appliances. Moreover, the information that is necessary for authentication between the home appliances and the key management device (that is, the authentication information) is stored beforehand in authentication tags, and the user can set this information in the home appliances directly using these authentication tags.

Moreover, a method for setting shared secret information in appliances has been proposed in which a shared key is set in appliances trying to communicate, using a communication device in which the shared key is stored in advance (see for example JP 2004-129257A).

The conventional method for setting secret information disclosed in JP 2004-129257A is described with reference to FIG. 13.

In FIG. 13, appliances 501 to 503, such as PCs, are provided with slots 511 to 513, respectively, for inserting a communication device 521 to 523 such as a wireless LAN card. Communication among the appliances 501 to 503 is possible by inserting the communication devices 521 to 523 into the slots 511 to 513, respectively.

Here, in order to perform communication among the appliances 501 to 503, first, a key module having the same ID or authentication code as the communication device 521 is inserted into the slot 511 of the appliance 501, and the ID or authentication code is stored in the appliance 501.

Then, the communication device 521 is authenticated using the ID or authentication code stored in the appliance 501.

Furthermore, the communication devices 522 and 523 are inserted into the slot 511 of the appliance 501, and the communication addresses stored by the communication devices 522, 523, and shared keys with unique settings, are registered in the appliance 501.

Similarly, after authenticating the communication device 522, the communication addresses of the communication devices 521, 523, and a shared key with unique settings, are registered by the appliance 502, and after authenticating the communication device 523, the communication addresses of the communication devices 521, 522, and a shared key with unique settings, are registered by the appliance 503.

In the method disclosed by JP 2004-129257A, shared keys are stored beforehand in communication devices corresponding in a one-to-one relationship to the appliances, and the shared keys are set by inserting the communication devices in other appliances. Moreover, the authentication information that is necessary for authentication between communication device and appliance is directly set in the appliances by a key module including this authentication information.

In the above-described conventional configuration disclosed in JP 2003-87238A, the information for authenticating appliances connected to the network and the shared encryption key that is used at the time of communication among the appliances are both managed by the key management device, and thus a key management device is necessary in addition to the communicating appliances and a setting medium, thus entailing a complicated system configuration.

Also, in the conventional configuration disclosed in JP 2004-129257A, the shared key is stored beforehand in the communication devices, and thus it cannot be changed, and moreover, there is a one-to-one relationship between the communication devices and the appliances, and thus the communication devices of the same number as appliances are necessary. Moreover, the shared key is fixed for a group of appliances, and thus communication with a different group is not possible unless a relay device with a data relaying function is used.

On the other hand, it is also conceivable that the range over which appliances can be connected and set up in a home is restricted, for reasons of copyright protection or the like, as a special feature desired in networked home appliances. However, the above-described conventional examples are only directed at easily setting the secret information in the appliances, and do not give any consideration to limiting the range over which the appliances can be set up.

It is thus an object of the present invention to solve the problems of the related art, and, by improving upon the related art, to provide a device with which secret information can be set easily and securely in appliances connected to a network, without a complicated system configuration. It is also an object of the present invention to provide a device with which secret information can be set only in networked home appliances within a limited set-up range and to provide a service ensuring that only networked home appliances within a limited set-up range can perform communication.

### DISCLOSURE OF THE INVENTION

A secret information setting device according to a first aspect of the present invention is a secret information setting device for generating secret information and setting secret information in a plurality of appliances in a system using shared secret information that allows the appliances to communicate over a network, the secret information setting device comprising a generation instruction receiving unit that receives a secret information generation instruction from a user; a secret information generation unit that generates the secret information in response to the secret information generation instruction received with the generation instruction receiving unit; a secret information storage unit that stores the secret information generated by the secret information generation unit; a secret information transfer unit that transfers the secret information stored in the secret information storage unit to the plurality of appliances; and a secret information deleting unit that deletes the secret information stored in the secret information storage unit when a predetermined condition is satisfied.

With this configuration, separate management devices or relay devices between the appliances in which the secret information is to be set are not required, and thus the system configuration can be simplified. Also, arithmetic processing for generating the secret information does not have to be carried out inside the appliances, and thus the load on the CPU of the appliances can be reduced. Furthermore, by letting the user set the secret information directly without using the network, the divulgence of secret information can be prevented, the user can set the secret information only in the desired appliances, and impersation and connection to the wrong appliances can be prevented. Moreover, the secret information setting device is configured such that the secret information stored in the secret information storage unit is deleted when a predetermined condition is satisfied, and thus the divulgence of secret information can be prevented, unauthorized use can be restricted, and lack of memory can be prevented.

A secret information setting device according to a second aspect of the present invention is a secret information setting device according to the first aspect of the present invention, wherein the secret information generation unit generates the secret information based on internal information managed inside the device.

Thus, a configuration is achieved with which the user himself will not know the secret information, and thus the divulgence of secret information can be prevented.

A secret information setting device according to a third aspect of the present invention is a secret information setting device according to the first aspect of the present invention, further comprising an external information receiving unit that receives external information that is externally input in order to generate the secret information; wherein the secret information generation unit generates the secret information based on the external information received by the external information receiving unit.

Thus, the secret information can be generated based on information that the user can know through a user operation, and thus the user-friendliness and the user's sense of security are enhanced.

A secret information setting device according to a fourth aspect of the present invention is a secret information setting device according to the third aspect of the present invention, wherein the external information receiving unit is an input device, such as a keyboard or a pointing device for data input.

Thus, the user can easily input the external information, and the degree of freedom for information that can be entered is high.

A secret information setting device according to a fifth aspect of the present invention is a secret information setting device according to the third aspect of the present invention, wherein the external information receiving unit is an image input device into which captured image information is input as the external information.

Thus, image information captured with a digital camera for example can be taken as the secret information, which makes the device user-friendly and makes it possible to increase security by using complex images.

A secret information setting device according to a sixth aspect of the present invention is a secret information setting device according to any of the third to fifth aspect of the present invention, wherein the secret information generation unit takes the external information received with the external information receiving unit as the secret information.

Thus, the external information is used directly as the secret information, and thus complicated arithmetic processing for generating the secret information can be omitted, and the load on the CPU can be reduced.

A secret information setting device according to a seventh aspect of the present invention is a secret information setting device according to any of the third to fifth aspect of the present invention, wherein the secret information generation unit generates the secret information by arithmetically processing the external information received with the external information receiving unit.

Thus, the secret information is generated based on external information entered by the user, and thus security can be enhanced by preventing secret information from being generated improperly. Also, the user himself cannot know the secret information that is actually set, and thus disclosure of the secret information can be prevented.

A secret information setting device according to an eighth aspect of the present invention is a secret information setting device according to the first aspect of the present invention, wherein the secret information storage unit further stores the number of times that the secret information has been transferred to the outside; and wherein the secret information transfer unit transfers the secret information to a number of appliances corresponding to the number of transfer times stored in the secret information storage unit.

Thus, it is possible to set the secret information only in particular appliances, and secret information can be prevented from being set in the wrong appliances.

A secret information setting device according to a ninth aspect of the present invention is a secret information setting device according to the eighth aspect of the present invention, further comprising a transfer time setting unit for setting the number of transfer times that the secret information is transferred to the outside; wherein the secret information storage unit stores the number of transfers set by the transfer time setting unit.

Thus, the number of appliances to which the secret information is transferred can be easily changed, and it is possible to transfer a secret information to a plurality of appliances.

A secret information setting device according to a tenth aspect of the present invention is a secret information setting device according to the eighth aspect of the present invention, wherein the secret information deleting unit deletes the secret information stored in the secret information storage unit, if the secret information transfer unit has transferred the secret information to a number of appliances corresponding to the number of transfers stored in the secret information storage unit.

Thus, the secret information stored in the secret information storage unit is automatically deleted after a predetermined number of transfers, and thus the divulgence of secret information because the user forgot to delete it can be prevented.

A secret information setting device according to an eleventh aspect of the present invention is a secret information setting device according to the first aspect of the present invention, further comprising a clock unit that measures the time that has elapsed after a predetermined time and outputs this clock information; and a time limit judgment unit that determines the integrity of the secret information stored in the secret information storage unit by comparing the clock information that is output from the clock unit with judgment reference information; wherein the secret information deleting unit deletes the secret information stored in the secret information storage unit based on a determination of the time limit judgment unit.

Thus, the security can be enhanced by restricting a period of the storing of the secret information in the secret information storage unit. For example, the secret information setting device can be configured such that the time that has elapsed after the secret information has been set is measured, and the secret information is deleted after a predetermined time has elapsed.

A secret information setting device according to a twelfth aspect of the present invention is a secret information setting device according to the eleventh aspect of the present invention, wherein the clock unit measures the time that has elapsed from the time when the secret information generation unit has generated the secret information.

Thus, the secret information setting device can be configured such that the secret information is automatically deleted even when secret information has been erroneously generated and is not transferred to an appliance.

A secret information setting device according to a thirteenth aspect of the present invention is a secret information setting device according to the eleventh aspect of the present invention, wherein the clock unit measures the time that has elapsed from the time when the secret information transfer unit has first transferred the secret information.

Thus, the set-up range of appliances in which the secret information is set can be restricted by setting the predetermined time to a time in which the secret information can be set in the appliances within one home, for example.

A secret information setting device according to a fourteenth aspect of the present invention is a secret information setting device according to the thirteenth aspect of the present invention, wherein the time limit judgment unit determines an appliance type to which the secret information transfer unit transfers the secret information, and sets the judgment reference information based on that appliance type.

Thus, the judgment reference information can be set in accordance with the appliance type in which the secret information is set, and a time can be provided that is limited in accordance with the appliance type in which the secret information is set, making it possible to prevent secret information from being set in the wrong appliances.

A secret information setting device according to a fifteenth aspect of the present invention is a secret information setting device according to the thirteenth aspect of the present invention, wherein the time limit judgment unit determines a function type that is carried out using the secret information, and sets the judgment reference information based on that function type.

Thus, the judgment reference information can be set in accordance with the function type used by the appliances, and a time can be provided that is limited in accordance with the function type used by the appliances, making it possible to prevent secret information from being set in the wrong appliances.

A secret information setting device according to a sixteenth aspect of the present invention is a secret information setting device according to the fourteenth or fifteenth aspect of the present invention, further comprising a type value receiving unit receiving input of a type value representing the appliance type or the function type; wherein the time limit judgment unit sets the judgment reference information based on the type value received with the type value receiving unit.

Thus, the secret information setting device can be configured to allow a user to set the function type or the appliance type in which the secret information is to be set.

A secret information setting device according to a seventeenth aspect of the present invention is a secret information setting device according to the fourteenth or fifteenth aspect of the present invention, wherein the judgment reference information is an upper time limit based on that type value.

Thus, it becomes possible to restrict the range over which the appliances can be set up, and to prevent secret information from being set in appliances that are set up at unspecified remote locations.

A secret information setting device according to an eighteenth aspect of the present invention is a secret information setting device according to the seventeenth aspect of the present invention, further comprising an extension instruction receiving unit that receives an instruction to extend the upper time limit; wherein the time limit judgment unit changes the judgment reference information in response to an extension instruction received with the extension instruction receiving unit.

Thus, it is possible to accommodate cases where there is the risk of failure to set the secret information in the appliances within the predetermined time set by the judgment reference information.

A secret information setting device according to a nineteenth aspect of the present invention is a secret information setting device according to the first aspect of the present invention, wherein the secret information storage unit stores the number of appliances to which the secret information has been transferred by the secret information transfer unit; and wherein the secret information setting device further comprises a transfer number display unit that displays the number of appliances stored in the secret information storage unit.

Thus, if secret information is set in a plurality of appliances, then it is easy to determine the number of appliances that have already been set or the remaining number of setting procedures, which enhances user-friendliness.

A secret information setting device according to a twentieth aspect of the present invention is a secret information setting device according to the first aspect of the present invention, further comprising a power supply unit that supplies power for a predetermined time to the secret information storage unit; wherein the secret information storage unit stores the secret information only as long as power is supplied to it from the power supply unit.

Thus, the secret information is automatically deleted at the time when the power supplied to the secret information storage unit is depleted, and thus disclosure of the secret information can be prevented.

A communication system according to a twenty-first aspect of the present invention is a communication system using shared secret information to allow a plurality of appliances to communicate over a network, the communication system comprising a secret information setting device according to the first aspect of the present invention, which is not connected to the network; wherein the secret information setting device generates the secret information, and sets the secret information in the plurality of appliances without using the network.

Thus, separate management devices or relay devices between the appliances in which the secret information is to be set are not required, and thus the system configuration can be simplified. Also, arithmetic processing for generating the secret information does not have to be carried out inside the appliances, and thus the load on the CPU of the appliances can be reduced. Furthermore, by letting the user set the secret information directly without using the network, the divulgence of secret information can be prevented, the user can set the secret information only in the desired appliances, and impersation and connection to the wrong appliances can be prevented. Moreover, the communication system is configured such that the secret information stored in the secret information storage unit is deleted when a predetermined condition is satisfied, and thus the divulgence of secret information can be prevented, unauthorized use can be restricted, and lack of memory can be prevented.

A communication system according to a twenty-second aspect of the present invention is a communication system according to the twenty-first aspect of the present invention, wherein the secret information setting device is a portable device.

Thus, the procedure for setting the secret information in the appliances is made easy.

A communication system according to a twenty-third aspect of the present invention is a communication system according to the twenty-first aspect of the present invention, wherein the secret information setting device is a mobile phone terminal.

Thus, the secret information can be easily set in the appliances, using a mobile phone terminal currently in widespread use.

A communication system according to a twenty-fourth aspect of the present invention is a communication system according to the twenty-first aspect of the present invention, wherein the secret information setting device is a remote control for a home appliance.

Thus, the secret information can be easily set in the appliances, using a remote control belonging to a home appliance.

A secret information setting method according to a twenty-fifth aspect of the present invention is a method for generating secret information and setting secret information in a plurality of appliances in a system using shared secret information that allows the appliances to communicate over a network, the secret information setting method comprising the steps of receiving a secret information generation instruction from a user; generating the secret information in response to the received secret information generation instruction; storing generated secret information in a secret information storage unit; transferring the secret information stored in the secret information storage unit to the plurality of appliances; and deleting the secret information stored in the secret information storage unit when a predetermined condition is satisfied.

Thus, separate management devices or relay devices between the appliances in which the secret information is to be set are not required, and thus the system configuration can be simplified. Also, arithmetic processing for generating the secret information does not have to be carried out inside the appliances, and thus the load on the CPU of the appliances can be reduced. Furthermore, by letting the user set the secret information directly without using the network, the divulgence of secret information can be prevented, the user can set the secret information only in the desired appliances, and impersation and connection to the wrong appliances can be prevented. Moreover, the secret information setting method is configured such that the secret information stored in the secret information storage unit is deleted when a predetermined condition is satisfied, and thus the divulgence of secret information can be prevented, unauthorized use can be restricted, and lack of memory can be prevented.

A program according to a twenty-sixth aspect of the present invention is a program for a secret information setting method for generating secret information and setting secret information in a plurality of appliances in a system using shared secret information that allows the appliances to communicate over a network, the program performing on a computer a secret information setting method comprising the steps of receiving a secret information generation instruction from a user; generating the secret information in response to the received secret information generation instruction; storing generated secret information in a secret information storage unit; transferring the secret information stored in the secret information storage unit to the plurality of appliances; and deleting the secret information stored in the secret information storage unit when a predetermined condition is satisfied.

Such a program may be recorded on a portable recording medium, such as a CD-ROM or flexible disk, or on another recording device that is connected over a communication line, or it can be recorded on a recording medium such as the hard-disk or the RAM of a computer, and the program may be loaded into the main memory of a computer for execution. Consequently, by executing the program on a device provided with a CPU, a memory and an interface, it is possible to configure a device that can execute the secret information setting method.

A recording medium according to a twenty-seventh aspect of the present invention is a computer-readable recording medium storing a program for a secret information setting method for generating secret information and setting secret information in a plurality of appliances in a system using shared secret information that allows the appliances to communicate over a network, the secret information setting method comprising the steps of receiving a secret information generation instruction from a user; generating the secret information in response to the received secret information generation instruction; storing generated secret information in a secret information storage unit; transferring the secret information stored in the secret information storage unit to the plurality of appliances; and deleting the secret information stored in the secret information storage unit when a predetermined condition is satisfied.

Such a recording medium may be a CD-ROM or flexible disk, an optomagnetic disk, a portable recording medium such as a memory card, another recording device that is connected over a communication line, or the hard-disk or RAM of a computer, and the secret information setting device can be configured by executing the program recorded on the recording medium on a device including a CPU and a memory or the like.

With the present invention, a relay device or a management device for managing secret information is not necessary in a system requiring shared secret information to allow a plurality of appliances to communicate with one another over a network, and thus the system configuration can be simplified. Moreover, the amount of computation necessary to set the secret information does not require extensive processing since there is no need to generate the secret information in each of the appliances, and thus the processing load on the CPUs of the appliances can be reduced.

Furthermore, by letting the user set the secret information in the appliances directly without using a network, the divulgence of secret information can be prevented, the user can set the secret information only in the appliances that are supposed to communicate with one another, and impersation and connection to the wrong appliances can be prevented. Here, an example of secret information is key information for shared key encryption or information serving as a password for authentication, but in the present invention there is no particular limitation to the secret information.

Moreover, the generated secret information is deleted if a certain condition is satisfied, and secret information is not accumulated in the memory. Consequently, it is possible to prevent lack of memory, and a non-volatile memory is not necessarily required. Furthermore, since no secret information is accumulated, unauthorized use of the secret information at different locations or disclosure of the secret information can be prevented even if the secret information setting device is stolen.

Moreover, it can be ensured that the secret information is automatically deleted after it has been transferred to the appliances for a predetermined number of times, and thus the secret information can be prevented from being set in the wrong appliances, and the divulgence of secret information because the user forgot to delete it can be prevented. It should be noted that it is also possible that the number of transfers of the secret information may be specified, and that the number of appliances in which the secret information is set can be easily increased.

Also, a configuration is possible in which the secret information is deleted if the setting of the secret information is not terminated within a predetermined time. In this case, the user can set the shared secret information only in networked home appliances within a restricted range. For example, if an upper time limit is used for the time interval between settings, then it can be ensured that networked home appliances that are located at an unspecified distance that cannot be reached within the upper time limit do not function properly, and thus a service can be provided which ensures that only networked home appliances within a limited set-up range can communicate with each other. It is also possible to use a lower time limit in addition to the upper time limit.

Moreover, by providing different time restrictions for type values representing different appliances or functions or services, it is possible to flexibly adjust the set-up range. Thus, it is possible to accommodate the intentions of copyright owners or service providers.

Also, by making it possible to extend the time limit, the possibility of failure to set the secret information can be mitigated.

With the present invention as described above, it is possible to provide, in a system that requires shared secret information for letting a plurality of appliances communicate over a network, a unit for setting secret information in the appliances connected to the network in a simple and secure manner without a complex system configuration, and a unit for setting secret information that enables a service in which only networked home appliances within a set-up range specified by a copyright holder or the like can communicate.

### BRIEF DESCRIPTION OF THE DRAWINGS

FIG. 1 is a functional block diagram of a secret information setting device according to a first embodiment of the present invention.

FIG. 2 is a control flowchart of the secret information setting device according to the first embodiment of the present invention.

FIG. 3 is a functional block diagram of a secret information setting device according to a second embodiment of the present invention.

FIG. 4 is a control flowchart for the generation of secret information with the secret information setting device according to the second embodiment of the present invention.

FIG. 5 is a functional block diagram of a secret information setting device according to a third embodiment of the present invention.

FIG. 6 is a control flowchart of the secret information setting device according to the third embodiment of the present invention.

FIG. 7 is a block diagram showing the hardware configuration of a secret information setting device according to a fourth embodiment of the present invention.

FIG. 8 is a functional block diagram of a secret information setting device according to a fifth embodiment and a sixth embodiment of the present invention.

FIG. 9 is a control flowchart of the secret information setting device according to the fifth embodiment of the present invention.

FIG. 10 is a control flowchart of the secret information setting device according to the sixth embodiment of the present invention.

FIG. 11 is a diagram showing a configuration of a communication system to which a secret information setting method according to the first embodiment of the present invention can be applied.

FIG. 12 is a diagram illustrating a conventional system.

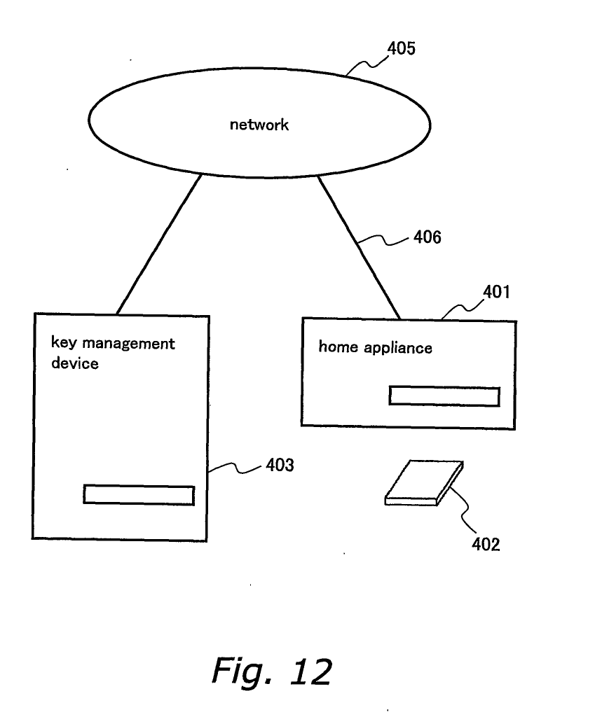

FIG. 13 is a diagram illustrating another conventional system.

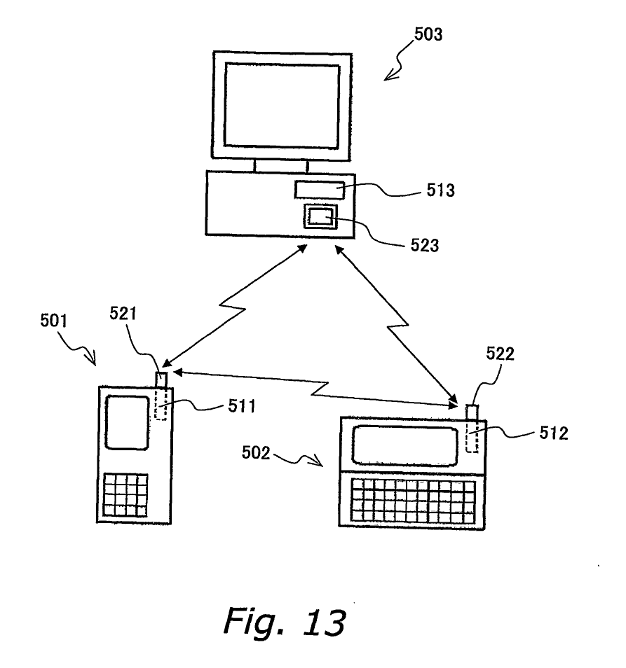

### BEST MODE FOR CARRYING OUT THE INVENTION

The following is an description of preferred embodiments of the present invention, with reference to the accompanying drawings.

### First Embodiment

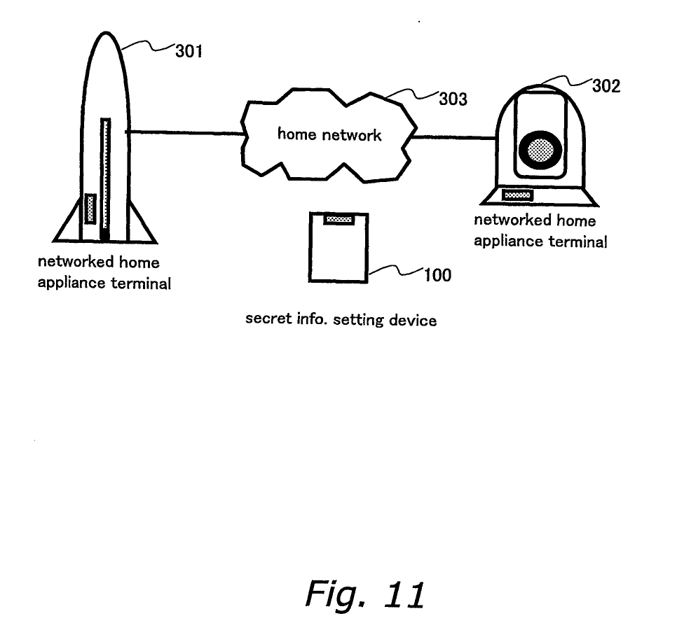

FIG. 11 is a diagram showing a configuration example of a communication system to which a secret information setting method according to a first embodiment of the present invention can be applied. In FIG. 11, a home gateway connected to a home network 303 serves as a networked home appliance terminal 301, a network camera connected to the home network 303 serves as a networked home appliance terminal 302, and a portable special terminal provided with an LSI or the like in which functions to generate and set secret information are programmed serves as a secret information setting device 100.

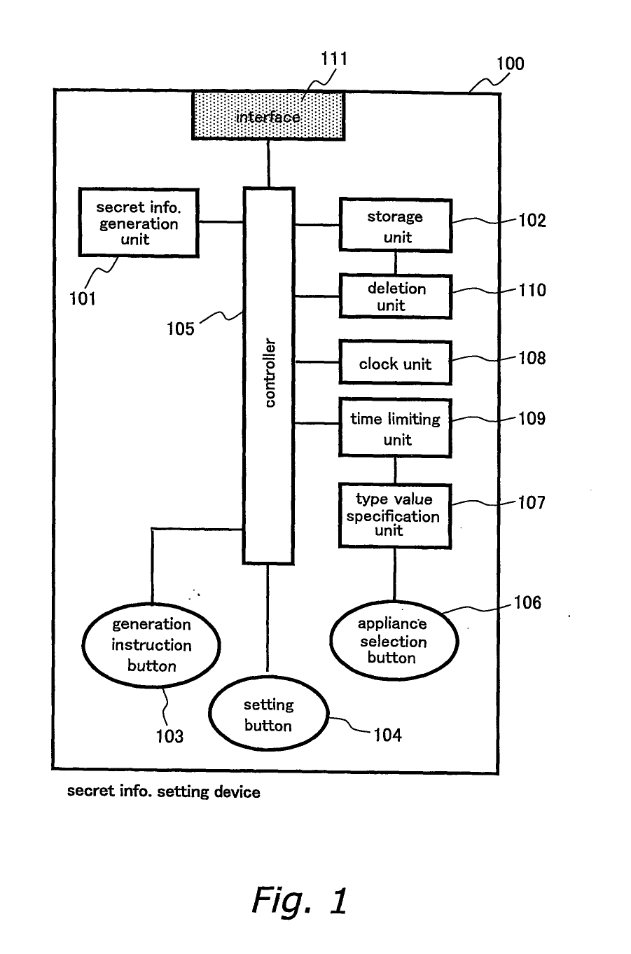

FIG. 1 is a functional block diagram showing the configuration of the secret information setting device 100 according to the first embodiment of the present invention.

The secret information setting device 100 in FIG. 1 includes an interface 111 exchanging secret information with networked home appliance terminals (not shown in FIG. 1); a secret information generation unit 101 generating secret information; a storage unit 102 for storing the generated secret information; a generation instruction button 103 with which a user can enter a secret information generation instruction; a setting button 104 with which the user can enter a command for setting the secret information in an appliance; an appliance selection button 106 with which the user can enter a selection instruction for selecting an appliance to be set; a type value specification unit 107 for receiving an input from the appliance selection button 106 and determining and outputting a type value corresponding to an appliance; a clock unit 108 for counting the time that has passed after receiving a count start instruction and for outputting clock information; a time limiting unit 109 for comparing the clock information that is output from the clock unit 108 with predetermined judgment reference information and making a decision on integrity; a deletion unit 110 for deleting secret information stored in the storage unit 102 when certain conditions are satisfied; and a controller 105 for controlling all these units.

Here, when the clock unit 108 does not measure the time that has elapsed, then it outputs clock information of the value “0”. Also, an upper generation time limit defining an upper limit to the time that passes from the time when the generation instruction button 103 is pressed until the setting button 104 is pressed is assigned in advance as the judgment reference information.

Assuming that secret information is set in two appliances, the operation of this first embodiment is described for a situation in which the number of transfers stored in the storage unit is 2. When a transfer unit has transferred the secret information twice, then the process of setting the secret information in all appliances is completed.

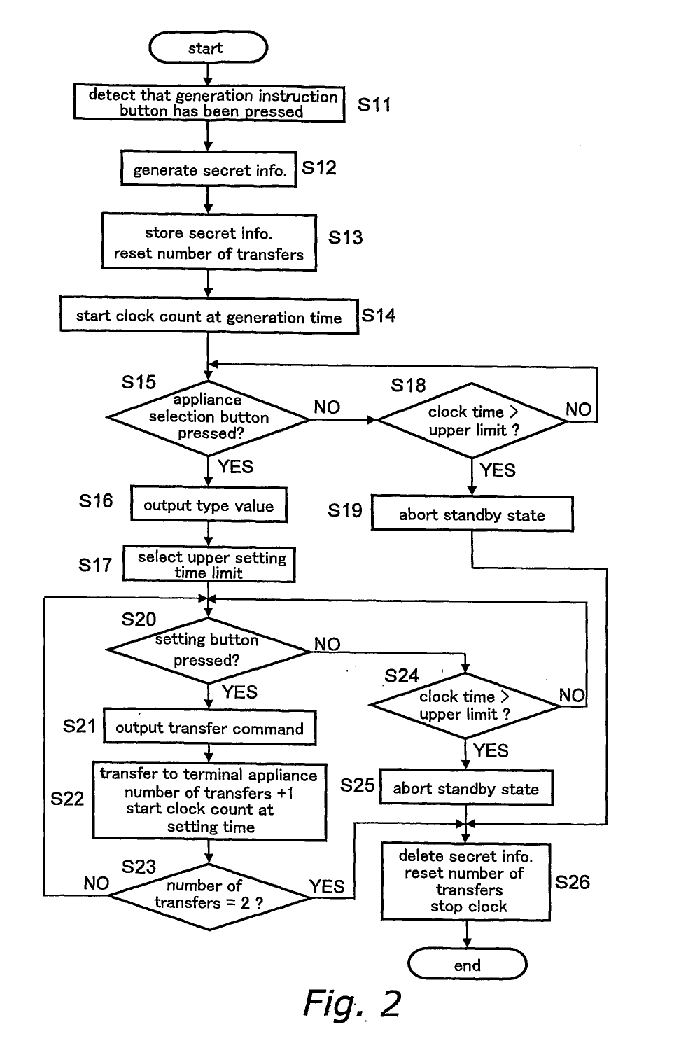

FIG. 2 is a control flowchart for the setting of secret information with the secret information setting device 100 according to the first embodiment of the present invention.

When it is detected that the generation instruction button 103 has been pressed (Step S11), then the controller 105 instructs the secret information generation unit 101 to generate secret information. In response to the secret information generation instruction from the controller 105, the secret information generation unit 101 generates secret information to be set in the networked home appliance terminals, and passes the generated secret information to the storage unit 102 (Step S12).

The storage unit 102 stores the received secret information in a predetermined region and resets the transfer number to “0” (Step S13).

At the same time, the controller 105 instructs the clock unit 108 to start counting, and lets the clock unit 108 measure the time that has elapsed from the secret information generation time (Step S14).

Until the controller 105 detects that the setting button 104 has been pressed, the time limiting unit 109 compares the clock information output from the clock unit 108 with predetermined judgment reference information and continuously determines the integrity.

The controller 105 waits for the pressing of the appliance selection button 106 for selecting a networked home appliance in which the secret information is to be set (Step S15).

If the clock information exceeds the judgment reference information (upper time limit) so that the time limiting unit 109 detects an elapsed time that is “out of bounds” while waiting at Step S15 until detecting that the appliance selection button 106 is pressed (Step S18), then the time limiting unit 109 sends to the controller 105 a signal that the elapsed time is out of bounds (Step S19). The controller 105 receives this that the elapsed time is out of bounds and aborts the standby state of Step S15. After the controller 105 has aborted the standby state, the deletion unit 110 deletes the secret information in the storage unit 102, the number of transfers is reset, the clock unit 108 is stopped, and the process is terminated (Step S26).

When the controller 105 detects at Step S15 that the appliance selection button 106 has been pressed, then an appliance type value set by the type value specification unit 107 in accordance with the pressing state of the appliance selection button 106 is obtained (Step S16).

The time limiting unit 109 selects an upper setting time limit in accordance with the appliance type value determined by the type value specification unit 107 (Step S17).

It should be noted that until the pressing of the setting button 104 is detected, the previously set upper generation time limit is taken as the judgment reference information, and only the upper setting time limit is selected in Step S17.

If the clock information exceeds the judgment reference information (upper time limit) so that the time limiting unit 109 detects an elapsed time that is “out of bounds” while waiting at Step S20 until detecting that the setting button 104 is pressed (Step S24), then the time limiting unit 109 sends to the controller 105 a signal indicating the fact that the elapsed time is out of bounds (Step S25). The controller 105 receives this signal indicating the fact that the elapsed time is out of bounds and aborts the standby state of Step S20. After the controller 105 has aborted the standby state, the deletion unit 110 deletes the secret information in the storage unit 102, the number of transfers is reset, the clock unit 108 is stopped, and the process is terminated (Step S26).

When the controller 105 detects at Step S20 that the setting button 104 has been pressed, then it instructs the storage unit 102 to transfer the secret information to the networked home appliance terminal (Step S21). In response to the transfer instruction from the controller 105, the storage unit 102 transfers the stored secret information via the interface 111 to the networked home appliance terminal and increments the number of transfers stored in the storage unit 102. Furthermore, based on the fact that the secret information has been transferred to the appliance, the controller 105 instructs the time limiting unit 109 to change the judgment reference information to the upper setting time limit, and instructs the clock unit 108 to again count the time that has elapsed from the setting of the secret information (Step S22). In response to the instruction to change the judgment reference information from the controller 105, the time limiting unit 109 changes the judgment reference information to the upper setting time limit that has been selected at Step S17. Also, based on the instruction from the controller 105 to count again, the count unit 108 resets the elapsed time that has been counted so far to “0” and again counts the elapsed time.

Through this operation, the secret information has been transferred to the first appliance.

After the transfer of the secret information, the controller 105 determines whether the number of transfers has reached the number of appliances for which the setting of the secret information was planned (two in this case) (Step S23). If the controller 105 determines that the number of transfers has not yet reached the number of appliances for which the setting of the secret information was planned, then the process from Step S20 onward is repeated. If the controller 105 determines that the number of transfers has reached the number of appliances for which the setting of the secret information was planned, then the controller 105 deletes the secret information in the storage unit 102 with the deletion unit 110, resets the number of transfers, stops the clock unit 108, and terminates the process (Step S26).

In the first embodiment, the number of appliances in which secret information is set is two, and thus the procedure returns to waiting for the user's next request to set the secret information (Step S20).

If the clock information exceeds the judgment reference information (upper time limit) so that the time limiting unit 109 detects an elapsed time that is “out of bounds” while waiting at Step S20 until detecting that the setting button 104 is pressed (Step S24), then the time limiting unit 109 sends to the controller 105 a signal indicating the fact that the elapsed time is out of bounds (Step S25). The controller 105 receives this signal indicating the fact that the elapsed time is out of bounds and aborts the standby state of Step S20. After the controller 105 has aborted the standby state, the deletion unit 110 deletes the secret information in the storage unit 102, the number of transfers is reset, the clock unit 108 is stopped, and the process is terminated (Step S26).

It should be noted that this first embodiment is described for a situation in which the number of appliances in which secret information is set is two and the number of transfers of secret information is also two, but it is also possible to further provide a transfer number setting unit for receiving instructions regarding the number of transfers of secret information (number of appliances in which secret information is set), in order to set the secret information in more than two appliances. In this case, it is easy to change the number of appliances in which the secret information is set.

The method for generating the secret information may use information managed inside the secret information setting device 100, such as time information or random numbers, but there is no particular limitation to the method for generating the secret information.

The secret information setting device 100 may be further provided with a button for receiving an instruction to delete secret information, making it possible to delete secret information by pressing this button. Thus, secret information can be deleted without waiting for a predetermined time, which makes it possible to increase security and shorten the time until the secret information is reset.

The button for receiving the instruction to generate secret information and the button for receiving the instruction to delete secret information may be devised as the same button, which may be configured such that secret information is generated and stored when this button is pressed down by the user and the secret information is deleted when the user releases the button. With this configuration, the secret information is stored only for the time that the button is pressed, thus preventing unauthorized use of the secret information at a different location, even when the secret information setting device 100 is stolen or lost.

It is furthermore possible that the type value specification unit 107 determines, in response to the pressing of the appliance selection button 106, appliance type values of a plurality of appliances in which secret information is set, or function type values of functions that operate using the secret information, and that the time limiting unit 109 selects an upper setting time limit, in accordance with the appliance type values or function type values of the plurality of appliances in which secret information is set determined by the type value specification unit 107. With this configuration, it is possible to provide different time limits for type values representing the differences between a plurality of appliances or functions or services, and to flexibly adjust the settings range.

Moreover, it was explained above that the appliance selection button 106 is pressed down before the secret information is transferred to the first appliance, but it is also possible that the appliance selection button 106 is pressed down for every appliance to which secret information is transferred.

With this configuration, the upper setting time limit is selected every time an appliance is selected, and thus the setting time can be limited to an upper setting time limit that is suitable for the function of each networked home appliance terminal. For example, it can be foreseen that a VCR for analog recording and a VCR for digital recording will have different ranges for communication.

Moreover, appliance type values may be assigned to the appliances in which the secret information is set, the secret information transfer unit 111 may receive the appliance type value of the set appliance when the secret information is transferred, and the time limiting unit 109 may automatically set an upper time limit serving as the judgment reference time in accordance with the appliance type value received by the secret information transfer unit 111.

Thus, it is not necessarily required to include the appliance selection button 106 and the type value specification unit 107 as structural elements.

It is also possible to provide a display unit for displaying the current status of, for example, the number of transfers or the number of remaining transfers of secret information, the upper time limit for the setting time and the time remaining until the upper time limit, or whether the secret information setting device 100 is currently holding secret information. However, regarding the content of the secret information, a display of a form that can be understood by the user and a configuration with which the secret information is not output are preferable. Such a display unit may be a liquid crystal display device displaying information with text or symbols, an LED displaying information by lighting up in different colors, an audio device for audibly giving off information by voice or audio, a vibrator giving tactile information by vibrations or the like, or any other kind of suitable device, and there is no particular limitation regarding the means and form of the display unit.

It should be noted that the upper setting time limit for setting secret information in two appliances can be set with the secret information setting device 100 of the present embodiment, thus enabling a distance limit due to the fact that the secret information setting device 100 can be operated only on appliances within a range to which it can be carried within that time. On the other hand, for communication not requiring such a distance limit, it is possible to avoid a limitation on the range in which the appliances can be set up by always letting the time limiting unit 109 output a “not out of bounds” judgment.

### Second Embodiment

The following is a second embodiment of the present invention.

The above-described first embodiment is configured so that the secret information is generated automatically inside the secret information setting device 100 when the generation instruction button 103 is pressed. The second embodiment, on the other hand, is further provided with an information input unit 113 for inputting the secret information or an element of the secret information. The secret information can be generated based on external information by entering that external information from the outside.

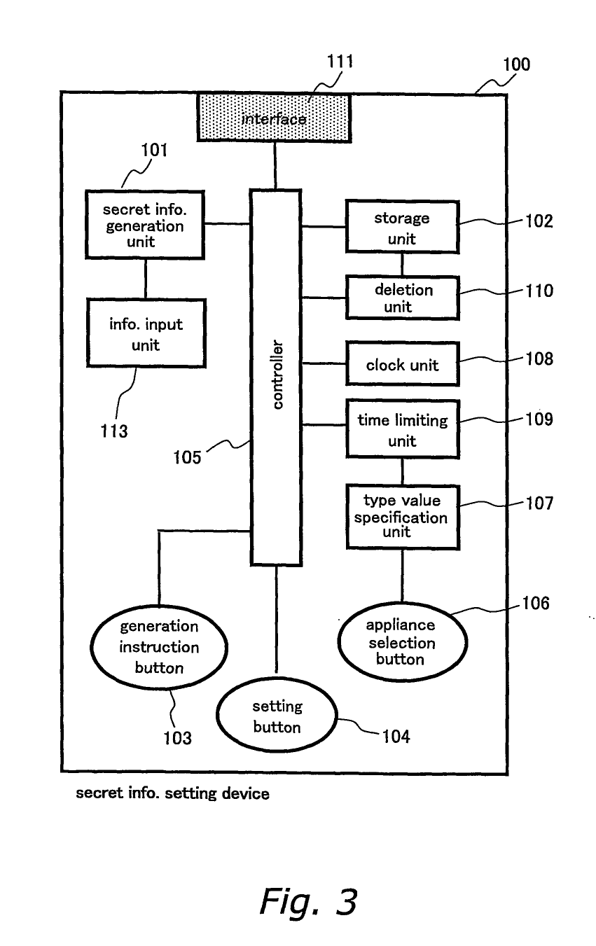

FIG. 3 is a functional block diagram showing the configuration of a secret information setting device 100 in accordance with the second embodiment of the present invention. Comparing the functional block diagram in FIG. 3 to the functional block diagram in FIG. 1, it can be seen that the difference is that in FIG. 3 an information input unit 113 is provided. Other structural elements are the same as in FIG. 1, and thus elements that are the same as in FIG. 1 are denoted by the same numerals and their further description have been omitted.

In FIG. 3, the secret information setting device 100 includes an interface 111, a secret information generation unit 101, a storage unit 102, a generation instruction button 103, a setting button 104, an appliance selection button 106, a type value specification unit 107, a clock unit 108, a time limiting unit 109, a deletion unit 110, a controller 105 and an information input unit 113.

Here, when the clock unit 108 does not measure the time that has elapsed, it outputs clock information of the value “0”. Also, an upper generation time limit defining an upper limit to the time that passes from the time when the generation instruction button 103 is pressed until the setting button 104 is pressed is assigned in advance as the judgment reference information.

Assuming that secret information is set in two appliances, the operation of this second embodiment is described for a situation in which the number of transfers stored in the storage unit is 2. When the transfer unit has transferred the secret information twice, then the process of setting secret information in all appliances is completed.

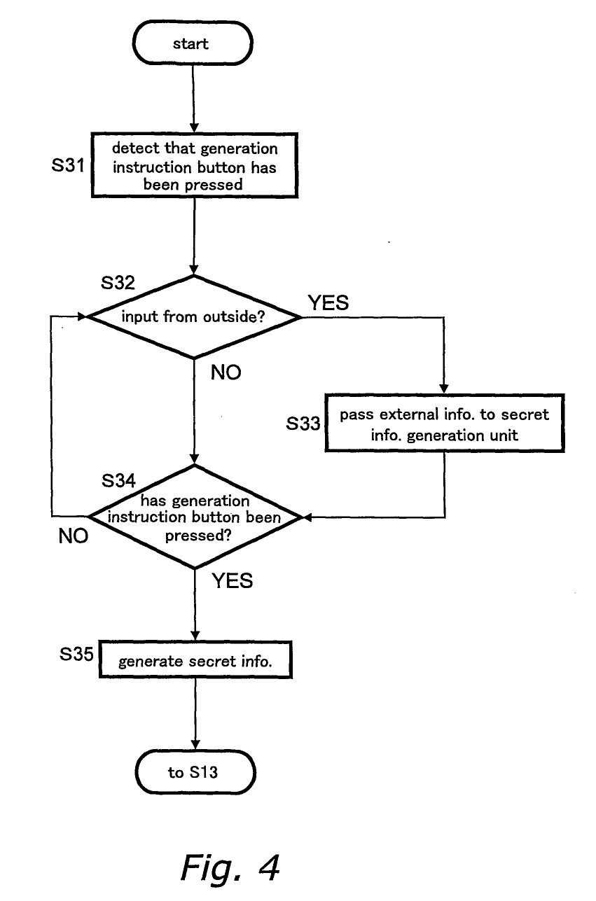

FIG. 4 is a control flowchart for the setting of secret information with the secret information setting device 100 according to the second embodiment of the present invention.

When it is detected that the generation instruction button 103 has been pressed (Step S31), then the controller 105 goes into standby mode waiting for the input of external information from the information input unit 113 (Step S32).

The controller 105 keeps waiting for the input of the secret information or an element of the secret information from the information input unit 113 until it detects that the generation instruction button 103 has been pressed again, and every time external information is entered from the information input unit 113, that entered external information is passed to the secret information generation unit 101 (Step S33).

When it is detected that the generation instruction button 103 has been pressed again (Step S34), the controller 105 instructs the secret information generation unit 101 to generate secret information. In response to the instruction to generate secret information from the controller 105, the secret information generation unit 101 generates the secret information to bet set in the networked home appliance terminals using the external information entered through the information input unit 113 (Step S35).

The process of transferring the secret information to the networked home appliance terminals is the same as shown in Steps S13 to S26 in FIG. 2, and thus further description thereof has been omitted.

Possible methods for entering information with the information input unit 113 include input through a keyboard, input using a pointing device such as a mouse or a trackball, input from an appliance in which the secret information has been set, input of image information taken with a camera, barcode input with a camera or a light-receiving element, electronic watermarking through an extraction process based on a camera image, or any other suitable input method, and there is no particular limitation to the input method.

Also, it is possible to use all of the information entered through the information input unit 113 for the generation of the secret information, to use only a portion of the entered external information for the generation of the secret information, or to generate the secret information by subjecting the entered information to a computation process, but there is no particular limitation to this.

Moreover, it is also possible to measure the time that has elapsed after the generation instruction button 103 has been pressed for the first time and to delete the external information that has been input through the information input unit 113 and terminate the processing if the generation of the secret information has not been completed within the time limit. Thus, the processing can be terminated after the upper time limit when the generation instruction button 103 has been pressed accidentally.

Thus, with the present embodiment, a generation instruction can be received from the user and the secret information can be generated using external input.

### Third Embodiment

The following is an explanation of a third embodiment of the present invention.

In the first embodiment described above, the secret information is deleted after a set time limit has been reached, whereas in the third embodiment, it is possible to extend this time limit.

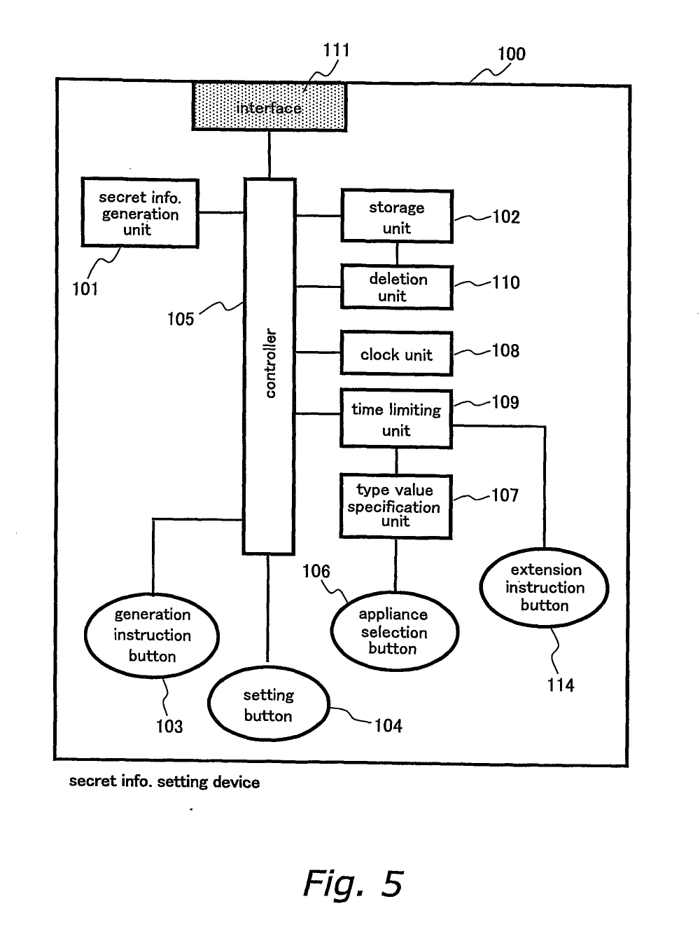

FIG. 5 is a functional block diagram showing the configuration of a secret information setting device 100 in accordance with a third embodiment of the present invention. Comparing the functional block diagram in FIG. 5 to the functional block diagram in FIG. 1, it can be seen that the difference is that in FIG. 5 an extension instruction button 114 is provided. Other structural elements are the same as in FIG. 1, and thus elements that are the same as in FIG. 1 are denoted by the same numerals and further description thereof have been omitted.

In FIG. 5, the secret information setting device 100 includes an interface 111, a secret information generation unit 101, a storage unit 102, a generation instruction button 103, a setting button 104, an appliance selection button 106, a type value specification unit 107, a clock unit 108, a time limiting unit 109, a deletion unit 110, a controller 105 and an extension instruction button 114.

Here, when the clock unit 108 does not measure the time that has elapsed, it outputs clock information of the value “0”. Also, an upper generation time limit defining an upper limit to the time that passes from the time when the generation instruction button 103 is pressed until the setting button 104 is pressed is assigned in advance as the judgment reference information.

Assuming that secret information is set in two appliances, the operation of this third embodiment is described for a situation in which the number of transfers stored in the storage unit is 2. When the transfer unit has transferred the secret information twice, then the process of setting secret information in all appliances is completed.

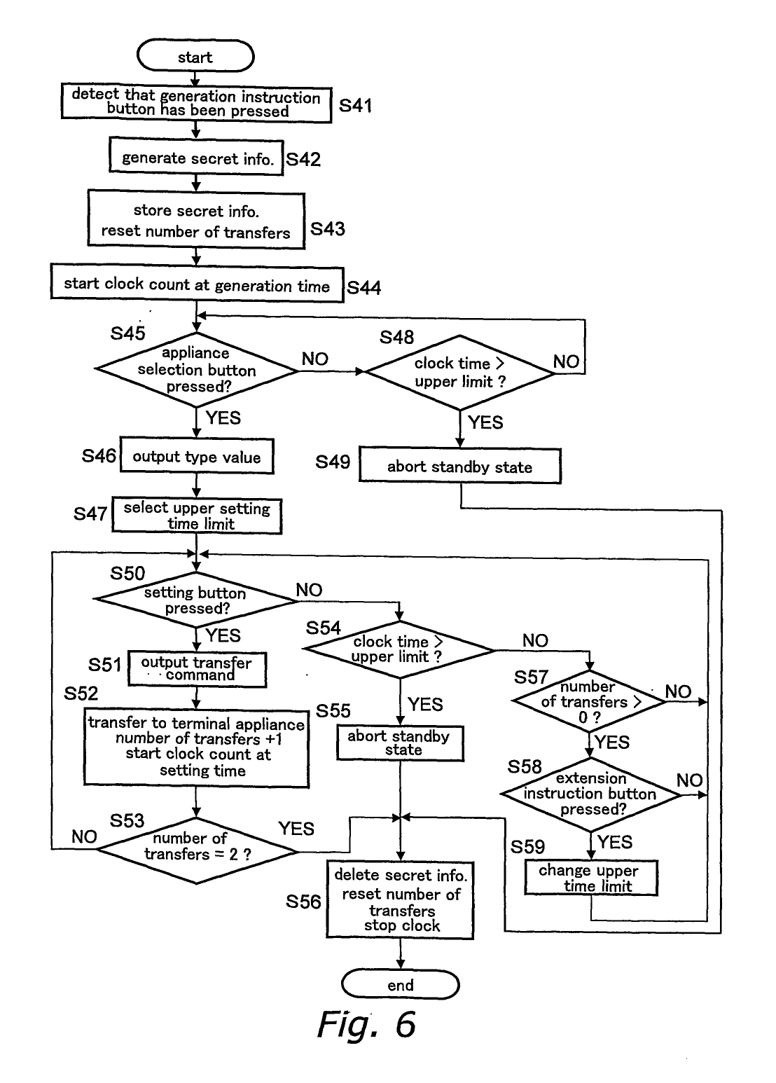

FIG. 6 is a control flowchart for the setting of secret information with the secret information setting device 100 according to the third embodiment of the present invention.

When it is detected that the generation instruction button 103 has been pressed (Step S41), then the controller 105 instructs the secret information generation unit 101 to generate secret information. In response to the secret information generation instruction from the controller 105, the secret information generation unit 101 generates secret information to be set in the networked home appliance terminals, and passes the generated secret information to the storage unit 102 (Step S42).

The storage unit 102 stores the received secret information in a predetermined region and resets the transfer number to “0” (Step S43).

At the same time, the controller 105 instructs the clock unit 108 to start counting, and lets the clock unit 108 measure the time that has elapsed from the secret information generation time (Step S44).

Until the controller 105 detects that the setting button 104 has been pressed, the time limiting unit 109 compares the clock information output from the clock unit 108 with the predetermined judgment reference information and continuously decides on integrity.

The controller 105 waits for the pressing of the appliance selection button 106 for selecting a network home appliance for setting the secret information (Step S45).

If the clock information exceeds the judgment reference information (upper time limit) so that the time limiting unit 109 detects an elapsed time that is “out of bounds” while waiting at Step S45 until detecting that the appliance selection button 106 is pressed (Step S48), then the time limiting unit 109 sends to the controller 105 a signal indicating the fact that the elapsed time is out of bounds (Step S49). The controller 105 receives this signal indicating the fact that the elapsed time is out of bounds and aborts the standby state of Step S45. After the controller 105 has aborted the standby state, the deletion unit 110 deletes the secret information in the storage unit 102, the number of transfers is reset, the clock unit 108 is stopped, and the process is terminated (Step S56).

When the controller 105 detects at Step S45 that the appliance selection button 106 has been pressed, then an appliance type value set by the type value specification unit 107 in accordance with the pressing state of the appliance selection button 106 is obtained (Step S46).

The time limiting unit 109 selects an upper setting time limit in accordance with the appliance type value determined by the type value specification unit 107 (Step S47).

It should be noted that until the pressing of the setting button 104 is detected, the previously set upper generation time limit is taken as the judgment reference information, and only the upper setting time limit is selected in Step S47.

If the clock information exceeds the judgment reference information (upper time limit) so that the time limiting unit 109 detects an elapsed time that is “out of bounds” while waiting at Step S50 until detecting that the setting button 104 is pressed (Step S54), then the time limiting unit 109 sends to the controller 105 a signal indicating the fact that the elapsed time is out of bounds (Step S55). The controller 105 receives this signal indicating the fact that the elapsed time is out of bounds and aborts the standby state of Step S50. After the controller 105 has aborted the standby state, the deletion unit 110 deletes the secret information in the storage unit 102, the number of transfers is reset, the clock unit 108 is stopped, and the process is terminated (Step S56).

If, at Step S54, the time limiting unit 109 does not detect the measured time to be “out of bounds”, then the controller 105 determines whether the number of transfers is zero or not (Step S57). If the controller 105 determines that the number of transfers is zero, then the procedure returns to Step S50, and waits until the setting button 104 is pressed. If the controller 105 determines that the number of transfers is not zero, that is, if it is determined that the secret information has already been transferred to an appliance, then it is determined whether the extension instruction button 114 has been pressed (Step S58). The processing from Step S58 onward is described in the process carried out when waiting that the setting button 104 is pressed the second time.

When the controller 105 detects at Step S50 that the setting button 104 has been pressed, then it instructs the storage unit 102 to transfer the secret information to the networked home appliance terminal (Step S51). In response to the transfer instruction from the controller 105, the storage unit 102 transfers the stored secret information via the interface 111 to the networked home appliance terminal and increments the number of transfers stored in the storage unit 102. Furthermore, based on the fact that the secret information has been transferred to the appliance, the controller 105 instructs the time limiting unit 109 to change the judgement reference information to the upper setting time limit, and instructs the clock unit 108 to again count the time that has elapsed from the setting of the secret information (Step S52). In response to the instruction to change the judgment reference information from the controller 105, the time limiting unit 109 changes the judgment reference information to the upper setting time limit that has been selected at Step S47. Also, based on the instruction from the controller 105 to count again, the count unit 108 resets the elapsed time that has been counted so far to “0” and again counts the elapsed time.

Through this operation, the secret information has been transferred to the first appliance.

After the transfer of the secret information, the controller 105 determines whether the number of transfers has reached the number of appliances for which the setting of the secret information was planned (two in this case) (Step S53). If the controller 105 determines that the number of transfers has not yet reached the number of appliances for which the setting of the secret information was planned, then the process from Step S50 onward is repeated. If the controller 105 determines that the number of transfers has reached the number of appliances for which the setting of the secret information was planned, then the controller 105 deletes the secret information in the storage unit 102 with the deletion unit 110, resets the number of transfers, stops the clock unit 108, and terminates the process (Step S56).

On the other hand, if the clock information exceeds the judgment reference information (upper time limit) so that the time limiting unit 109 detects an elapsed time that is “out of bounds” while waiting at Step S50 until detecting that the setting button 104 is pressed for the second time (Step S54), then the time limiting unit 109 sends to the controller 105 a signal indicating the fact that the elapsed time is out of bounds (Step 55). The controller 105 receives this signal indicating the fact that the elapsed time is out of bounds and aborts the standby state of Step S50. After the controller 105 has aborted the standby state, the deletion unit 110 deletes the secret information in the storage unit 102, the number of transfers is reset, the clock unit 108 is stopped, and the process is terminated (Step S56).

If, at Step S54, the time limiting unit 109 does not detect the measured time to be “out of bounds”, then the controller 105 determines whether the number of transfers is zero or not (Step S57). If the controller 105 determines that the number of transfers is one, then it is determined whether the extension instruction button 114 has been pressed (Step S58). If the controller 105 determines that the extension instruction button 114 has been pressed, then the upper time limit (the judgment reference information) maintained by the time limiting unit 109 is changed (Step S59). For example, a predetermined extension time that was previously set may be added to the upper time limit that is currently set as the judgment reference information, and the added value may be taken as the new upper time limit. After that, the time limiting unit 109 takes the updated time limit as the judgment reference information to determine whether the elapsed time is out of bounds. If the extension instruction button 114 is not pressed, then the procedure returns to Step S50 and waits for the pressing of the setting button 104.

It is preferable that the extension of the upper time limit can be performed only once per secret information, and that the extension time does not exceed the originally set upper time limit, but there is no particular limitation regarding the number of possible extensions or the extension time.

Thus, with this embodiment, it is possible to extend the upper time limit. This makes it possible to reduce the possibilities for losing the settings of the secret information due to long distances between the locations where the appliances are set up within the home.

### Fourth Embodiment

The following is description of a fourth embodiment of the present invention.

In the above-described first embodiment, the secret information setting device 100 was taken to be a portable special terminal provided with an LSI or the like in which functions to generate and set secret information are programmed. In the fourth embodiment, on the other hand, the secret information setting device 100 is for example a mobile phone or a remote control, which is provided with a generic CPU, which reads in and executes a program realized by software shown in FIG. 1 (hereinafter referred to as “secret information setting program”). The functional configuration and operation formed by letting the secret information setting device 100 execute the secret information setting program is the same as in the first embodiment, and thus further description thereof has been omitted.

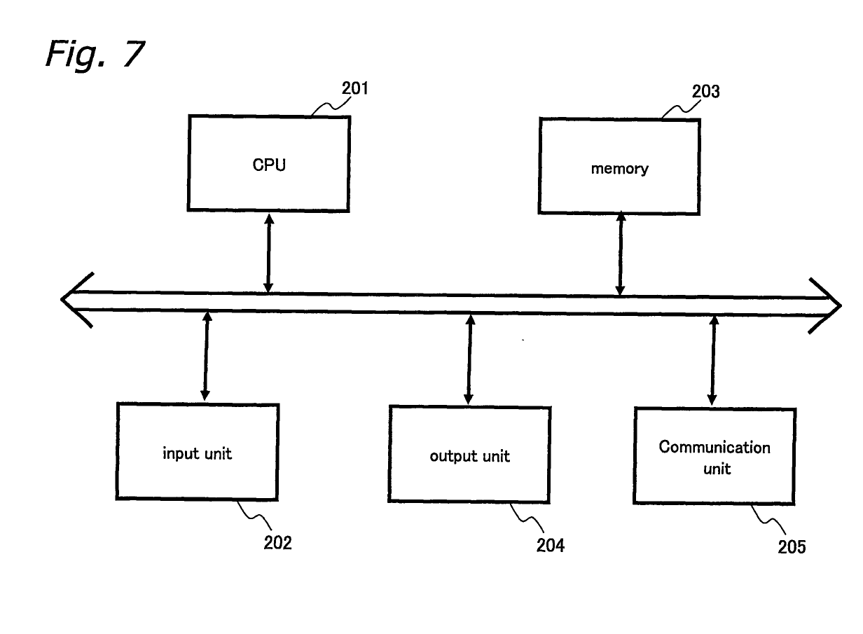

FIG. 7 is a block diagram showing the hardware configuration of the secret information setting device 100. This secret information setting device 100 includes a CPU 201, a memory 203, an input unit 202, an output unit 204, and a communication unit 205. The secret information setting program has been stored beforehand in the memory 203, and is read out into the CPU 201 as appropriate to be executed.

Comparing the functional block diagram shown in FIG. 1 with the hardware configuration of the secret information setting device 100 in FIG. 7, it can be seen that the input unit 202 corresponds to the generation instruction button 103, the setting button 104 and the appliance selection button 106. The memory 203 corresponds to the storage unit 102 in which the secret information is stored. The output unit 204 is a display device, such as a liquid crystal display, and corresponds to the display unit (not shown in the drawings). The communication unit 205 is made of the CPU 201 and a communication terminal such as a modem and corresponds to the interface 111. The CPU 201 executes functions corresponding to those of the secret information generation unit 101, the type value specification unit 107, the clock unit 108, the time limiting unit 109, and the deletion unit 110.

When the CPU 201 receives a generation instruction from the input unit 202, it reads the secret information setting program from the memory 203, and the generation of secret information begins.

It should be noted that in this embodiment, the secret information setting program is stored beforehand in the memory. Here, the secret information setting program may also be stored on a recording medium, such as an optical disk or a flexible disk or the like, or may be stored on a memory card, such as a SD memory card or a smart media card. The secret information generation program may also be provided over a network.

Moreover, the input unit 202 can be configured to include the information input unit 113 of the second embodiment, and the secret information setting device 100 may be configured such that the secret information is generated based on the external information that the user inputs via the information input unit 113, or such that the external information entered via the information input unit 113 is set, as is, as the secret information or as an element of the secret information in the networked home appliance terminals. As mentioned in the second embodiment, methods for entering information with the information input unit 113 include user input with a keyboard, input from an appliance in which the secret information has been set, input of image information taken with a camera, barcode input and electronic watermarking input, but there is no particular limitation to the input method. Also, if an extension input button 114 is to be included as in the third embodiment, then the input unit 202 may serve as the extension input button 114.

Also, as a method for detecting the connection between the secret information setting device 100 and the interface of the networked home appliance terminal, electrical detection methods and mechanical detection methods are conceivable, but there is no particular limitation to this detection method.

### Fifth Embodiment

The following is description of a fifth embodiment of the present invention. In this fifth embodiment, the electric power for generating and setting the secret information is replenished from the outside.

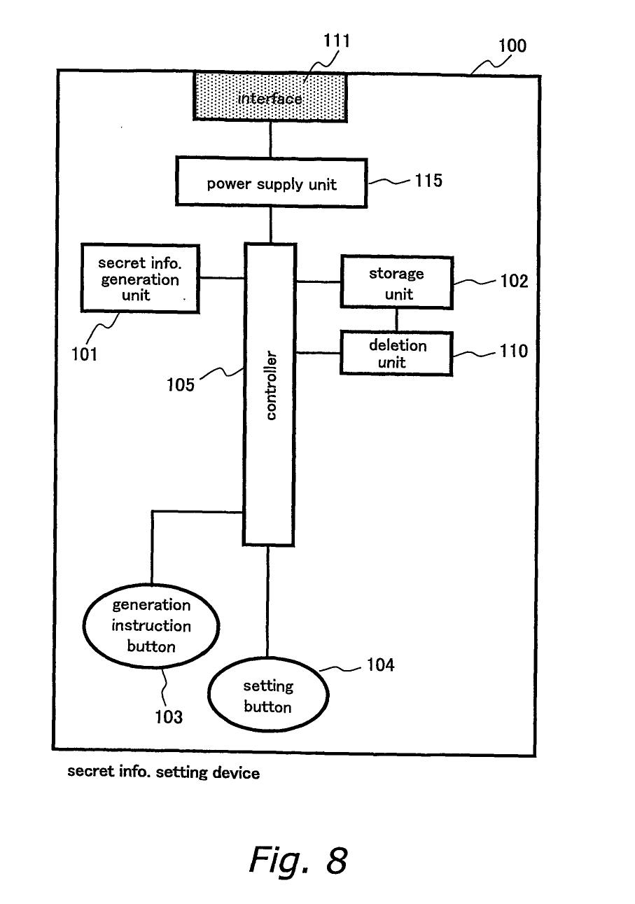

FIG. 8 is a functional block diagram showing the detailed configuration of a secret information setting device 100 in accordance with a fifth embodiment of the present invention. Structural elements that are the same as in FIG. 1 are denoted by the same numerals, and thus further description thereof have been omitted.

In FIG. 8, the secret information setting device 100 includes an interface 111, a secret information generation unit 101, a storage unit 102, a generation instruction button 103, a setting button 104, a deletion unit 110, a controller 105, and a power supply unit 115.

In this secret information setting device 100, power for the generation and setting of the secret information is received from another appliance via the interface 111, and this power is stored in a power supply unit 115. The power supply unit 115 supplies the power that has been replenished via the interface 111 through the controller 105 to the various units, ensuring in particular that the information stored in the storage unit 102 (composed of a volatile memory) is maintained.

Assuming that secret information is set in two appliances, the operation of this embodiment is described for a situation in which the number of transfers stored in the storage unit is 2. When the transfer unit has transferred the secret information twice, then the process of setting the secret information in all appliances is completed.

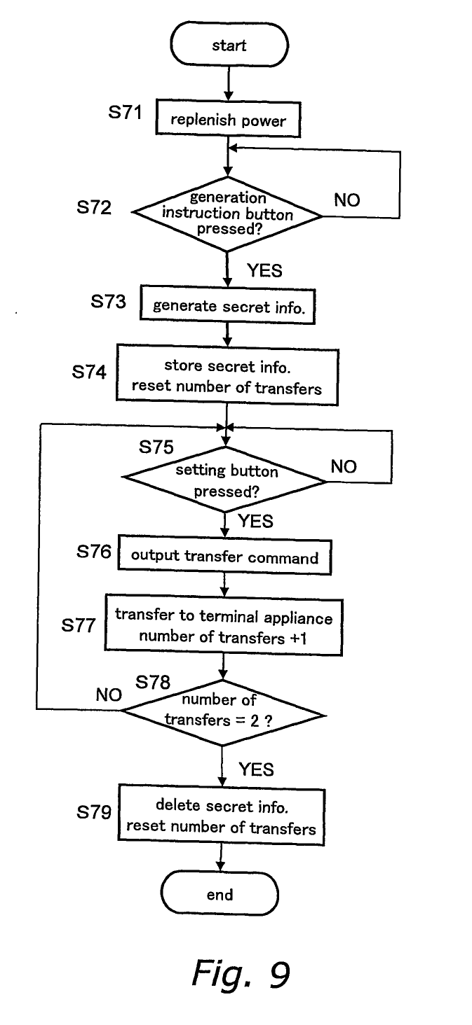

FIG. 9 is a control flowchart for the setting of secret information with the secret information setting device 100 according to this fifth embodiment of the present invention.

When power is supplied from another appliance via the interface 111, then the controller 105 stores this power in the power supply unit 115 (Step S71), and waits until the generation instruction button 103 is pressed (Step S72).

When it is detected that the generation instruction button 103 has been pressed (Step S72), then the controller 105 instructs the secret information generation unit 101 to generate secret information. In response to the secret information generation instruction from the controller 105, the secret information generation unit 101 generates secret information to be set in the networked home appliance terminals, and passes the generated secret information to the storage unit 102 (Step S73).

The storage unit 102 stores the received secret information in a predetermined region and resets the transfer number to “0” (Step S74).

When the controller 105 detects that the setting button 104 has been pressed (Step S75), the controller 105 instructs the storage unit 102 to transfer the secret information to the networked home appliance terminal (Step S76). In response to the transfer instruction from the controller 105, the storage unit 102 transfers the stored secret information via the interface 111 to the networked home appliance terminal and increments the number of transfers stored in the storage unit 102 (Step S77).

After the transfer of the secret information, the controller 105 determines whether the number of transfers has reached the number of appliances for which the setting of the secret information was planned (Step S78). If the controller 105 determines that the number of transfers has not yet reached the number of appliances for which the setting of the secret information was planned, then the process from Step S75 onward is repeated. If the controller 105 determines that the number of transfers has reached the number of appliances for which the setting of the secret information was planned, then the controller 105 deletes the secret information in the storage unit 102 with the deletion unit 110, resets the number of transfers, and terminates the process (Step S79).

With the configuration of the present embodiment, if the controller 105 detects that the setting button 104 is pressed while there is still sufficient power supplied by the power supply unit 115 remaining, then the process of setting the secret information can be carried out for all networked home appliance terminals.

On the other hand, if the power supplied by the power supply unit 115 is depleted before the number of appliances for which the setting of the secret information was planned has been reached, then all the functions of the secret information setting device 100 are suspended, and the secret information stored in the storage unit 102 (composed of a volatile memory) is automatically deleted.

It should be noted that the present embodiment has been described for a situation in which power is replenished from an appliance, but it is also possible to replenish the power through charging with a battery, or to replenish the power with a device other than the secret information setting device 100, and there is no particular limitation.

Thus, even when the secret information setting device 100 does not include a unit for generating power, it is possible to generate and set secret information, and moreover, to provide the secret information setting device 100 with a function for automatically deleting the secret information.

Sixth Embodiment

The following is an explanation of a sixth embodiment of the present invention.

In the afore-described fifth embodiment, when no more power is supplied from the power supply unit 115, the secret information setting device 100 automatically suspends all its functions, whereas in the sixth embodiment, the controller 105 suspends all functions of the secret information setting device 100 after determining the remaining power of the power supply unit 115.

The functional block diagram illustrating the configuration of the secret information setting device 100 according to the sixth embodiment is the same as the functional block diagram in FIG. 8 illustrating the configuration of the secret information setting device 100 according to the fifth embodiment, and thus further description thereof has been omitted.

In this secret information setting device 100, the power for generating and setting secret information is received from another appliance via the interface 111, and this power is stored in the power supply unit 115. The power that has been replenished through the interface 111 is supplied by the power supply unit 115 through the controller 105 to the various units, thus maintaining, in particular, the information that is stored in the storage unit 102 (composed of a volatile memory).

Assuming that secret information is set in two appliances, the operation of this embodiment is described for a situation in which the number of transfers stored in the storage unit is 2, and when the transfer unit has transferred the secret information twice, then the process of setting the secret information in all appliances is completed.

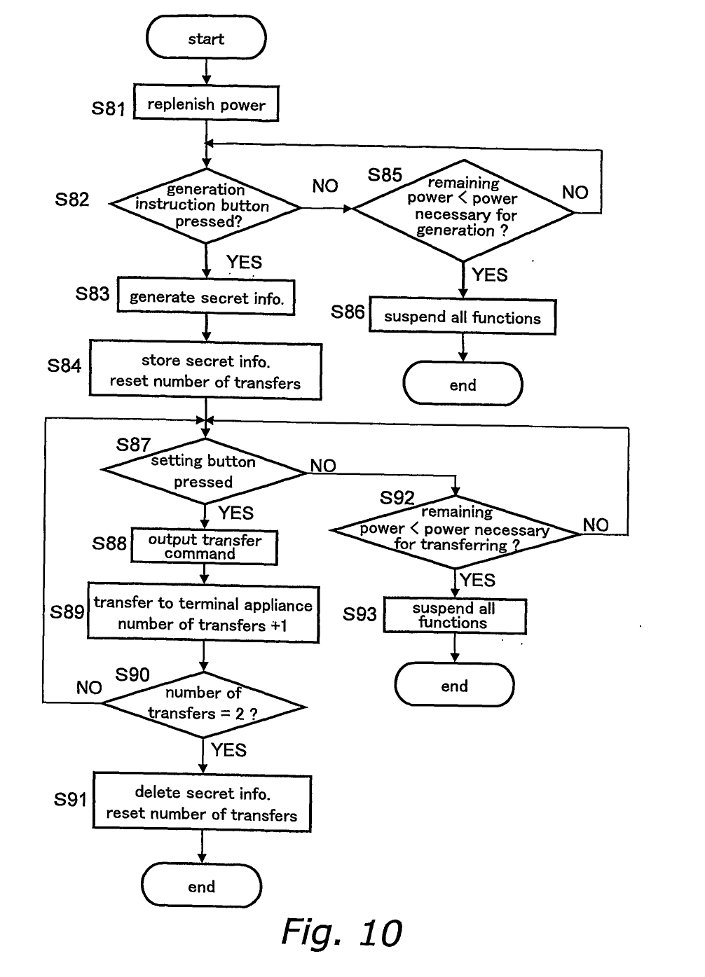

FIG. 10 is a control flowchart for the setting of secret information with the secret information setting device 100 according to this sixth embodiment of the present invention.

When power is supplied from another appliance via the interface 111, then the controller 105 stores this power in the power supply unit 115 (Step S81), and waits until the generation instruction button 103 is pressed (Step S82).

While waiting at Step S82 for the detection that the generation instruction button 103 has been pressed, the controller 105 determines whether the necessary power required to generate secret information is left in the power supply unit 115 (Step S85). If it determines that the remaining power is not sufficient for generating secret information, then all of the functions of the secret information setting device 100 are suspended (Step S86).

If it is detected that the generation instruction button 103 has been pressed while there is still sufficient power left to be supplied by the power supply unit 115 (Step S82), then the control unit 105 instructs the secret information generation unit 101 to generate secret information. In response to the secret information generation instruction from the controller 105, the secret information generation unit 101 generates secret information to be set in the networked home appliance terminals, and passes the generated secret information to the storage unit 102 (Step S83).

The storage unit 102 stores the received secret information in a predetermined region and resets the transfer number to “0” (Step S84).

While waiting at Step S87 for the detection that the setting button 104 has been pressed, the controller 105 determines whether the necessary power required to transfer the secret information is left in the power supply unit 115 (Step S92). If it determines that the remaining power is not sufficient for transferring the secret information, then all of the functions of the secret information setting device 100 are suspended, and the secret information stored in the storage unit 102, which is made of a volatile memory, is automatically deleted (Step S93).

If it is detected that the setting button 104 has been pressed while there is still sufficient power left to be supplied by the power supply unit 115 (Step S87), then the control unit 105 instructs the storage unit 102 to transfer the secret information to the networked home appliance terminal (Step S88). In response to the transfer instruction from the controller 105, the storage unit 102 transfers the stored secret information via the interface 111 to the networked home appliance terminal and increments the number of transfers stored in the storage unit 102. (Step S89).

After the transfer of the secret information, the controller 105 determines whether the number of transfers has reached the number of appliances for which the setting of the secret information was planned (Step S90). If the controller 105 determines that the number of transfers has not yet reached the number of appliances for which the setting of the secret information was planned, then the process from Step S87 onward is repeated. If the controller 105 determines that the number of transfers has reached the number of appliances for which the setting of the secret information was planned, then the controller 105 deletes the secret information in the storage unit 102 with the deletion unit 110, resets the number of transfers, and terminates the process (Step S91). Power that is not consumed is gradually lost over time.

It is also possible to devise a configuration including both the clock unit 108 and the time limiting unit 109, to calculate the time for which power can be supplied from the power supplied from another appliance via the interface 111 and take that time as the upper time limit of the judgment reference time, and to delete the secret information under certain time constraints.

Thus, the secret information setting device 100 can suspend all functions when it is not possible to generate or set the secret information with the power stored by the power supply unit 115.

By using a secret information setting device as described in the first to sixth embodiment, a separate appliance, such as a key management device or an authentication server for authenticating appliances in which the secret information is set is not necessary, which simplifies the system configuration.

Also, the processing load on the CPUs of the appliances that is necessary in order to generate secret information with the secret information setting device can be reduced.

Furthermore, the user holds the secret information setting device from the secret information generation start until the secret information is set in the appliances, and thus secret information will not be divulged during this period.

After the secret information has been set in the planned appliances, the remaining secret information is automatically deleted from the secret information setting device, and thus unauthorized use of that secret information at different locations can be prevented and no secret information is divulged, even if the secret information setting device is stolen.

Moreover, it is possible to establish an upper setting time limit when setting the secret information in a plurality of networked home appliance terminals, and to ensure that the secret information can be set only in networked home appliance terminals placed within a range over which the secret information setting device can be carried within this time. Therefore, when transmitting copyrighted works, such as movies, over a network, by limiting the communication function of the networked home appliance terminal such that the secret information set by the secret information setting device is necessary, communication exceeding a range that is limited by the carry time of the secret information setting device becomes impossible, and more effective copyright protection can be achieved.

### INDUSTRIAL APPLICABILITY

The secret information setting device according to the present invention allows settings to be made in a simple manner with little arithmetic processing load, and thus it is useful for secret information setting methods in home network systems connecting several networked home appliance terminals. Also, by limiting the time for which the secret information can be set in the networked home appliance terminals, the distance between locations at which networked home appliance terminals can be set up will be restricted, and thus it is useful for systems exchanging copyrighted works, such as home networks. Also, there is no limitation to home networks, and the secret information setting device according to the present invention is also useful in systems exchanging copyrighted works over the internet.

1-27. (canceled)

28. A secret information setting device for generating secret information and setting secret information in a plurality of appliances in a system using shared secret information that allows the appliances to communicate over a network, the secret information setting device comprising:
a generation instruction receiving unit that receives a secret information generation instruction from a user;
a secret information generation unit that generates the secret information in response to the secret information generation instruction received with the generation instruction receiving unit;
a secret information storage unit that stores the secret information generated by the secret information generation unit;
a secret information transfer unit that transfers the secret information stored in the secret information storage unit to the plurality of appliances; and
a secret information deleting unit that deletes the secret information stored in the secret information storage unit when a predetermined condition is satisfied.

29. The secret information setting device according to claim 28, wherein the secret information generation unit generates the secret information based on internal information managed inside the device.

30. The secret information setting device according to claim 28, further comprising:
an external information receiving unit that receives external information that is externally input in order to generate the secret information;
wherein the secret information generation unit generates the secret information based on the external information received by the external information receiving unit.

31. The secret information setting device according to claim 30, wherein the external information receiving unit is an input device, such as a keyboard or a pointing device for data input.

32. The secret information setting device according to claim 30, wherein the external information receiving unit is an image input device into which captured image information is input as the external information.

33. The secret information setting device according to claim 30, wherein the secret information generation unit takes the external information received with the external information receiving unit as said secret information.

34. The secret information setting device according to claim 30, wherein the secret information generation unit generates the secret information by arithmetically processing the external information received with the external information receiving unit.

35. The secret information setting device according to claim 28,
wherein the secret information storage unit further stores the number of times that the secret information has been transferred to the outside; and
wherein the secret information transfer unit transfers the secret information to a number of appliances corresponding to the number of transfer times stored in the secret information storage unit.

36. The secret information setting device according to claim 35, further comprising:
a transfer time setting unit for setting the number of transfer times that the secret information is transferred to the outside;
wherein the secret information storage unit stores the number of transfers set by the transfer time setting unit.

37. The secret information setting device according to claim 35, wherein the secret information deleting unit deletes the secret information stored in the secret information storage unit, if the secret information transfer unit has transferred the secret information to a number of appliances corresponding to the number of transfers stored in the secret information storage unit.

38. The secret information setting device according to claim 28, further comprising:
a clock unit that measures the time that has elapsed after a predetermined time and outputs this clock information; and
a time limit judgment unit that determines the integrity of the secret information stored in the secret information storage unit by comparing the clock information that is output from the clock unit with judgment reference information;
wherein the secret information deleting unit deletes the secret information stored in the secret information storage unit based on a determination of the time limit judgment unit.

39. The secret information setting device according to claim 38, wherein the clock unit measures the time that has elapsed from the time when the secret information generation unit has generated the secret information.

40. The secret information setting device according to claim 38, wherein the clock unit measures the time that has elapsed from the time when the secret information transfer unit has first transferred the secret information.

41. The secret information setting device according to claim 40, wherein the time limit judgment unit determines an appliance type to which the secret information transfer unit transfers the secret information, and sets the judgment reference information based on that appliance type.

42. The secret information setting device according to claim 40, wherein the time limit judgment unit determines a function type that is carried out using the secret information, and sets the judgment reference information based on that function type.

43. The secret information setting device according to claim 41, further comprising:
a type value receiving unit receiving input of a type value representing the appliance type;
wherein the time limit judgment unit sets the judgment reference information based on the type value received with the type value receiving unit.

44. The secret information setting device according to claim 42, further comprising:
a type value receiving unit receiving input of a type value representing the function type;
wherein the time limit judgment unit sets the judgment reference information based on the type value received with the type value receiving unit.

45. The secret information setting device according to claim 41, wherein the judgment reference information is an upper time limit based on that type value.

46. The secret information setting device according to claim 42, wherein the judgment reference information is an upper time limit based on that type value.

47. The secret information setting device according to claim 45, further comprising:
an extension instruction receiving unit that receives an instruction to extend the upper time limit;
wherein the time limit judgment unit changes the judgment reference information in response to an extension instruction received with the extension instruction receiving unit.

48. The secret information setting device according to claim 46, further comprising:
an extension instruction receiving unit that receives an instruction to extend the upper time limit;
wherein the time limit judgment unit changes the judgment reference information in response to an extension instruction received with the extension instruction receiving unit.

49. The secret information setting device according to claim 28, wherein:
the secret information storage unit stores the number of appliances to which the secret information has been transferred by the secret information transfer unit; and
the secret information setting device further comprises a transfer number display unit that displays the number of appliances stored in the secret information storage unit.

50. The secret information setting device according to claim 28,
further comprising a power supply unit that supplies power for a predetermined time to the secret information storage unit;
wherein the secret information storage unit stores the secret information only as long as power is supplied to it from the power supply unit.

51. A communication system using shared secret information to allow a plurality of appliances to communicate over a network, the communication system comprising:
a secret information setting device according to claim 28, which is not connected to the network;
wherein the secret information setting device generates the secret information, and sets the secret information in the plurality of appliances without using the network.

52. The communication system according to claim 51, wherein the secret information setting device is a portable device.

53. The communication system according to claim 51, wherein the secret information setting device is a mobile phone terminal.

54. The communication system according to claim 51, wherein the secret information setting device is a remote control for a home appliance.

55. A secret information setting method for generating secret information and setting secret information in a plurality of appliances in a system using shared secret information that allows the appliances to communicate over a network, the secret information setting method comprising the steps of:
receiving a secret information generation instruction from a user;
generating the secret information in response to the received secret information generation instruction;
storing generated secret information in a secret information storage unit;
transferring the secret information stored in the secret information storage unit to the plurality of appliances; and
deleting the secret information stored in the secret information storage unit when a predetermined condition is satisfied.

56. A program for a secret information setting method for generating secret information and setting secret information in a plurality of appliances in a system using shared secret information that allows the appliances to communicate over a network, the program performing on a computer a secret information setting method comprising the steps of:
receiving a secret information generation instruction from a user;
generating the secret information in response to the received secret information generation instruction;
storing generated secret information in a secret information storage unit;
transferring the secret information stored in the secret information storage unit to the plurality of appliances; and
deleting the secret information stored in the secret information storage unit when a predetermined condition is satisfied.

57. A computer-readable recording medium storing a program for a secret information setting method for generating secret information and setting secret information in a plurality of appliances in a system using shared secret information that allows those appliances to communicate over a network, the secret information setting method comprising the steps of:
receiving a secret information generation instruction from a user;
generating the secret information in response to the received secret information generation instruction;
storing generated secret information in a secret information storage unit;
transferring the secret information stored in the secret information storage unit to the plurality of appliances; and
deleting the secret information stored in the secret information storage unit when a predetermined condition is satisfied.
